(19) United States
(12) Patent Application Publication
(10) Pub. No.: US 2026/0048538 A1
(43) Pub. Date: Feb. 19, 2026

(54) METHOD FOR MANUFACTURING A DIAL ÉBAUCHE ATTACHED TO A REST PLATE

(71) Applicant: ETA SA Manufacture Horlogère Suisse, Grenchen (CH)

(72) Inventor: Yann ENGGIST, Ins (CH)

(73) Assignee: ETA SA Manufacture Horlogère Suisse, Grenchen (CH)

(21) Appl. No.: 19/262,897

(22) Filed: Jul. 8, 2025

(30) Foreign Application Priority Data
Aug. 19, 2024 (EP) 24195208.4

(51) Int. Cl. B29C 45/14; B29C 45/26; B29L 31/00

(52) U.S. Cl. CPC B29C 45/14065; B29C 45/26; B29C 2045/14122; B29L 2031/739

(57) ABSTRACT

A method for manufacturing a dial ébauche of a measuring apparatus mounted in a rest plate (3a, 3b) including: forming, in an enclosure of the mould (2), a central cavity (9a) and peripheral cavities (9b) defined around this central cavity (9a), the step (34) providing for fitting (35) the rest plate (3a, 3b) in this enclosure formed by a reversible assembly of first and second parts (7a, 7b) of this mould (2); designing the dial ébauche (4a, 4b) in the central cavity (9a) and attachment elements (10) in the peripheral cavities (9b), and unmoulding the rest plate (3a, 3b) from the mould (2), the plate including the dial ébauche (4a, 4b) and the designed attachment elements (10), ensuring the attachment of the ébauche (4a, 4b) in the plate (3a, 3b).

### CROSS REFERENCE TO RELATED APPLICATIONS

This application claims priority to European Patent Application No. 24195208.4, filed on Aug. 19, 2024, the entire contents of which are incorporated herein by reference.

### TECHNICAL FIELD OF THE INVENTION

The invention relates to a method and a system for manufacturing a dial ébauche for a measuring apparatus mounted in a rest plate/strip.

### TECHNOLOGICAL BACKGROUND

As part of the manufacture of dials for a measuring apparatus such as a watch, ébauches are traditionally made before subsequently undergoing finishing operations to produce the dials. For dials manufactured in mass production runs, or in order to reduce production costs, these ébauches are designed in moulds using material injection methods.

More specifically, this material is injected into the mould enclosure at an injection point located at the centre of the ébauche to be designed therein. Such an ebauche is then extracted from this enclosure by separating it from constituent parts that are not to be included on the resulting dial. This separation is generally done by blanking, stamping or machining with cutting tools, and has the drawback of potentially damaging the ébauche, which will not fit the dial to be manufactured, or soiling the ébauche, which would make it more difficult to carry out the finishing operations.

In this context, it is clearly understood that there is a need to develop alternative solutions that do not present the aforementioned drawbacks.

### SUMMARY OF THE INVENTION

The present invention aims to remedy all or part of the drawbacks referred to above by proposing a method and a system for manufacturing a dial ebauche contained in a rest plate, thereby simplifying the handling of this ébauche when it is extracted from the mould and also during the finishing operations that it must undergo.

To this end, one aspect of the invention relates to a method for manufacturing a dial ébauche of a measuring apparatus mounted in a rest plate comprising:
a step for forming, in an enclosure of said mould, a central cavity and peripheral cavities defined around this central cavity, said step providing for fitting the rest plate in this enclosure formed by a reversible assembly of first and second parts of this mould;
a step for designing said dial ébauche in the central cavity and attachment elements in the peripheral cavities, and
a step for unmoulding the rest plate from said mould, the plate comprising the dial ébauche and the designed attachment elements, said attachment elements ensuring the attachment of said ébauche in said plate.

In other embodiments:
during the fitting of the rest plate in said enclosure, a central opening and through holes of said plate are arranged, respectively, facing a central impression and peripheral impressions defined in an inner face of the first part, said face contributing to delimiting said enclosure of the mould;
during the fitting of the rest plate in said enclosure, exit ports of a material injection circuit comprised in a flat receiving face of the second part are each connected to a through hole of said plate;
in the design step, material is injected into the central cavity and peripheral cavities of the mould via exit ports comprised in the receiving face of the second part;
when injected, the material first penetrates into each peripheral cavity until it reaches the central cavity, where it accumulates to form the dial ébauche;
once the dial ébauche has been designed, the injected material continues to flow through the exit ports while accumulating in each peripheral cavity in order to form the attachment element provided with a breakaway junction part joining it to said dial ébauche;
the design step comprises making an injection point in an interface comprised between an exit port in a receiving face of the second part and a through hole in the plate;
the design step comprises regulating the temperature of the enclosure by performing an operation to cool the enclosure when the injection of material into said enclosure is complete;
the unmoulding step comprises detaching the first and second parts from each other;
the unmoulding step involves breaking the injection point configuring a base of one end of each attachment element flush with the bottom face of the rest plate;
the method comprises a step for designing the rest plate, which provides for making the central through opening and a plurality of through holes located at the periphery of this opening in the thickness of the body of this plate;
the method also comprises a step for preparing a central impression and peripheral impressions in the first part from at least one original part configured for making these said impressions in the inner face of this first part, and
said measuring apparatus is a watch.

The invention also relates to a system for manufacturing a dial ébauche of a measuring apparatus mounted in a rest plate using said method, the system comprising a mould comprising an enclosure including a central cavity and peripheral cavities defined around this central cavity, said enclosure being formed by a reversible assembly of first and second parts of this mould, said parts being configured to receive said rest plate, said central and peripheral cavities being configured for the design of the dial ébauche and attachment elements ensuring the attachment of said ébauche to said plate.

### BRIEF DESCRIPTION OF THE FIGURES

The purposes, advantages and characteristics of the present invention will become clearer from the following detailed description, provided in connection with the appended figures listed below:

FIG. 1 shows a system for manufacturing an ébauche for a dial of a measuring apparatus attached to a rest plate/strip, according to one embodiment of the invention;

FIG. 2 shows a rest plate without the dial ébauche that can be attached to it, according to the embodiment of the invention;

FIG. 3 is a cross-sectional view of part of a mould of the system in which the rest plate can be fitted, according to the embodiment of the invention;

FIGS. 4 and 5 show the rest plate comprising a single bed in which the designed dial ébauche is comprised and which is joined by attachment elements to this plate, according to the embodiment of the invention;

FIGS. 6 and 7 show the rest plate comprising a single bed in which is comprised a variant of the dial ébauche comprising a through opening which is joined by attachment elements to this plate, according to the invention;

FIG. 8 shows the rest plate comprising a number of beds, each including a dial ébauche, according to the embodiment of the invention, and

FIG. 9 is a flow chart relating to a method for manufacturing the dial ebauche mounted on the rest plate, according to the embodiment of the invention.

### DETAILED DESCRIPTION OF THE INVENTION

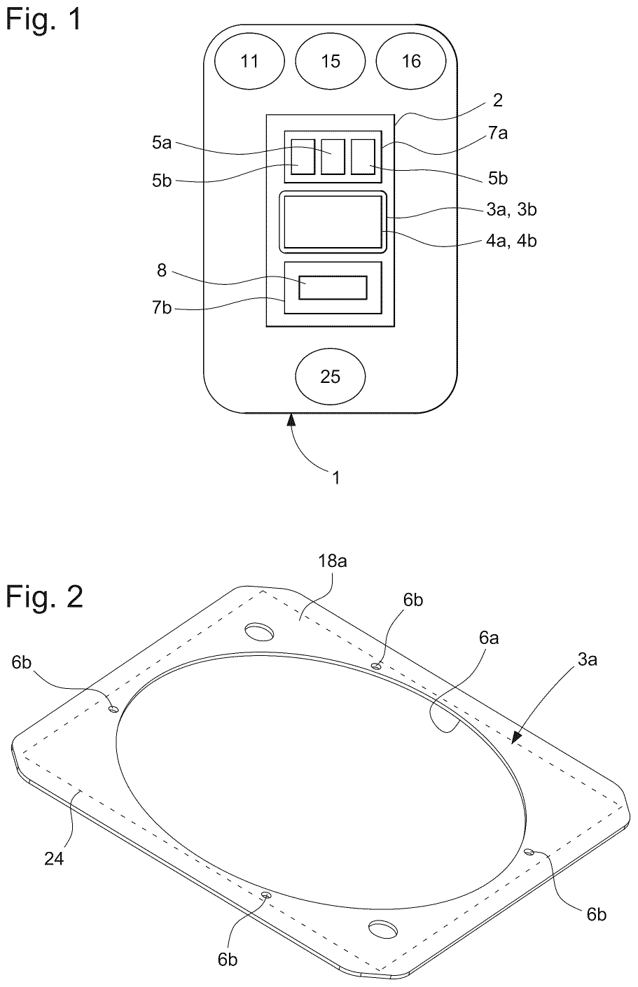

FIG. 1 shows a schematic representation of a system 1 for manufacturing at least one dial ébauche 4a, 4b for a measuring apparatus such as a watch or a gauge, said ébauche 4a, 4b being mounted/fastened in a rest plate 3a, 3b. It is understood that this can also be a system 1 for manufacturing a rest plate 3a, 3b comprising a dial ébauche 4a, 4b attached within it.

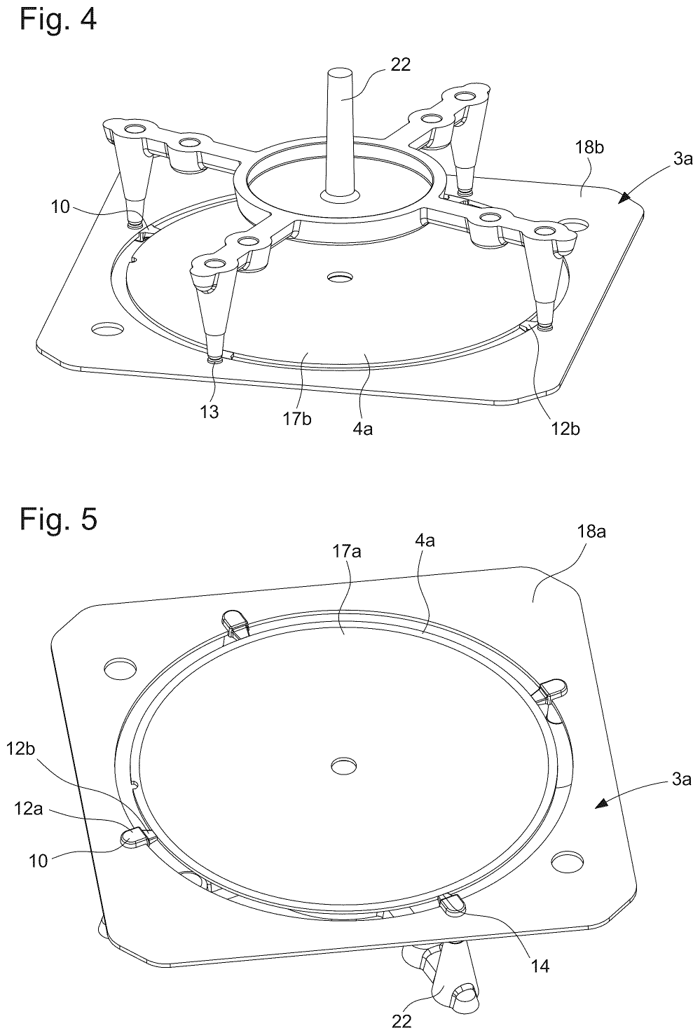

In this system 1, each dial ébauche 4a, 4b shown in FIGS. 4 to 8 comprises visible and hidden faces. The dial ébauche 4a, 4b also comprises a peripheral lateral wall connecting these visible and hidden faces to each other. It should be noted that the visible face 17a of this ébauche 4a, 4b corresponds to the face 17a which can be seen by the user of the measuring apparatus, for example the wearer of the watch, when the dial resulting from this ebauche 4a, 4b is mounted in this measuring apparatus. In other words, this face of the ebauche is said to be “visible” in reference to the fact that it can be seen when the dial produced from this ébauche 4a, 4b is mounted in the measuring apparatus, unlike the other face 17b of the ébauche 4a, 4b which is opposite this visible face 17a.

Such a system 1 can be used in an automatic assembly plant (or automatic assembly line) for manufacturing a dial or, more generally, for manufacturing all or part of the measuring apparatus. In such a context, this system 1 is involved in the manufacture and supply of dial ébauches 4a, 4b mounted/attached in the rest plate 3a, 3b at this automatic assembly plant. This plate 3a, 3b can then be manipulated to be arranged in another system at this facility such as a dial ébauche finishing system 4a, 4b to produce said dial to be mounted in the measuring apparatus.

With reference to FIGS. 1 to 3, this system 1 comprises, but is not limited to:
a mould 2 formed by reversible assembly of a first part 7a with a second part 7b, this mould being capable of receiving the rest plate 3a, 3b, also referred to as a strip or rest strip, capable of receiving at least one dial ébauche 4a, 4b;
a device 11 for injecting an injectable material into this mould 2;
a device 15 for creating a vacuum in the mould 2 and/or a device 16 for regulating the temperature inside the mould 2;
a device for unmoulding and fitting 25 the rest plate 3a, 3b;

In this system 1, the mould 2 comprises an enclosure formed by the assembly of the first part 7a with the second part 7b, and in which the rest plate 3a, 3b can be arranged.

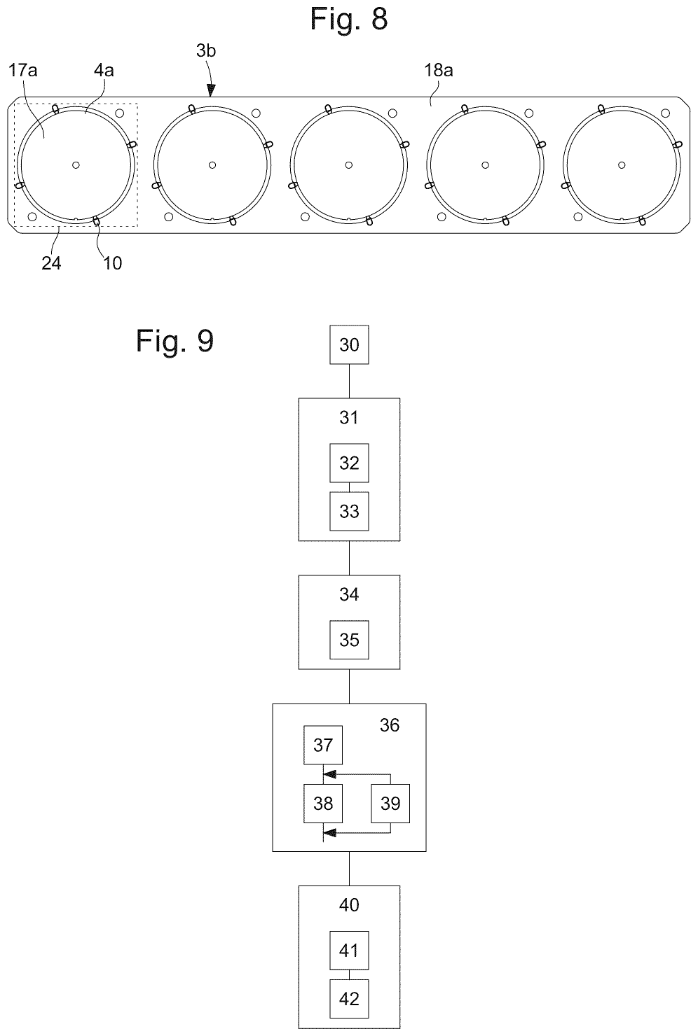

The rest plate 3a, 3b is a part made in one piece which can comprise a single bed 24 capable of holding the dial ébauche 4a, 4b as illustrated in FIGS. 4 to 7, or several preferably similar beds 24 as can be seen in FIG. 8.

For a better understanding of the present invention, the system 1 for manufacturing the ebauche 4a, 4b comprised in a rest plate 3a with a single bed 24 will be described below, the system being similar when the plate 3b comprises several beds 24. This bed 24, also referred to as a compartment, is therefore the part of the plate 3a, 3b comprising the dial ébauche 4a, 4b designed from the system 1.

This rest plate 3a, 3b comprises flat top and bottom faces 18a, 18b facing away from each other. In this configuration, each bed 24 comprises a central through opening 6a surrounded by a peripheral part of this plate 3a, 3b, this part comprising several through holes 6b. In this configuration, it is understood that these holes 6b are located on the periphery of this central opening 6a. These openings 6a and holes 6b open onto the top and bottom faces 18a, 18b of this plate 3a, 3b. It should be noted that each bed 24 comprises at least two through holes 6b and preferably four through holes 6b, as can be seen in FIGS. 2 and 8.

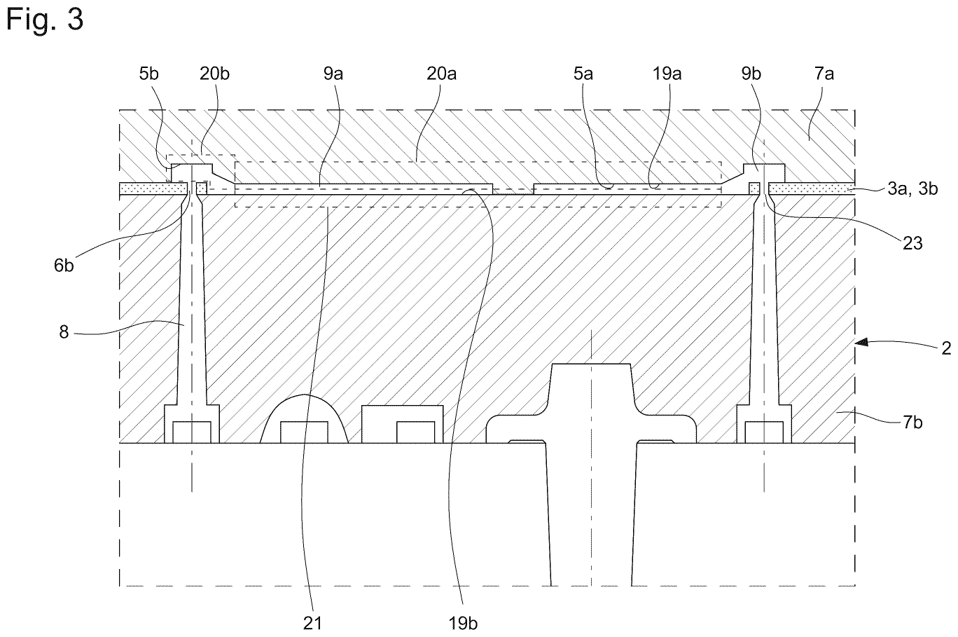

Referring to FIG. 3, in this mould 2, the second part 7b comprises a receiving face 19b for receiving such a rest plate 3a, 3b. This receiving face 19 is preferably flat but can comprise at least one cavity or counter-form or at least one protuberance or relief. More specifically, the rest plate 3a, 3b is mounted on the receiving face 19b of the second part 7b such that the hidden face 17b of the dial ébauche 4a, 4b to be designed is arranged facing or even in contact with all or part of this receiving face 19b. In this configuration, the visible face 17a of the dial ébauche 4a, 4b to be designed is positioned wholly or in part facing and/or in contact with an inner face 19a of the first part 7a. In other words, the rest plate 3a, 3b, and therefore the dial ébauche 4a, 4b, is arranged in the enclosure of this mould 2 by being sandwiched between the first and second parts 7a, 7b of this mould 2.

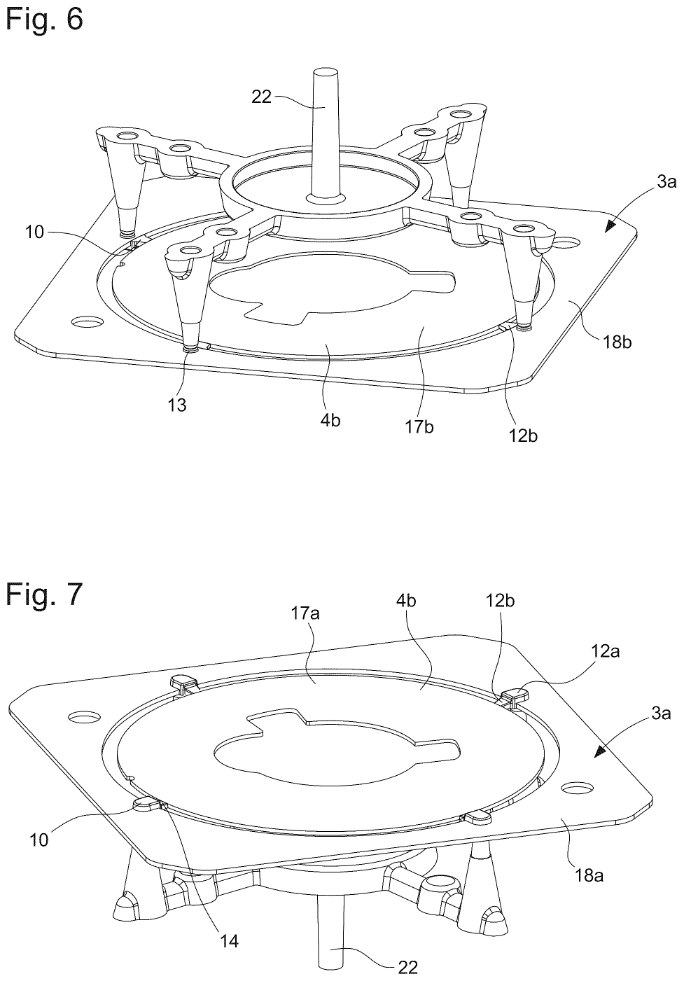

The inner face 19a of this first part 7a of the mould 2 comprises a central portion 20a and a peripheral portion 20b. The central portion 20a of this inner face 19a is designed to face a central zone 21 of the receiving face 19b of the second part 7b. This central portion 20a and the central zone 21 have areas which are similar to, and smaller than, that of the central opening 6a in the rest plate 3a. This central portion 20a comprises a single impression 5a, also referred to as the central impression 5a. This central impression 5a is configured to:
define (or at least contribute to defining) various characteristics of the dial ebauche 4a, 4b such as its overall shape, the shape of its axial and/or transverse section, its thickness, and/or
structure (or at least contribute to structuring) the visible face 17a of the dial ébauche 4a, 4b to be designed, by creating at least one pattern, at least one relief, at least one hollow, at least one cut-out and/or by making at least one blind hole, or even a through hole, in the thickness of the dial ébauche 4a, 4b (visible in FIGS. 6 and 7).

In other words, this central impression 5a can, for example, have at least one hollow shape and/or at least one relief or protuberance. The central portion 20a of the inner face 19a of this first part 7a and the central zone 21 of the receiving face 19b of the second part 7a together form a central cavity 9a of the mould 2 in which the dial ébauche 4a, 4b is designed/made.

Regarding the peripheral portion 20b of the inner face 19a, it is preferably flat and comprises several impressions 5b also referred to as peripheral impressions 5b. Such impressions 5b are configured to contribute to the design/production of the elements 10 attaching the dial ébauche 4a, 4b to the rest plate 3a. Preferably, each impression 5b is configured to form an attachment element 10 consisting of two parts: a part 12a for anchoring to the rest plate 3a and a part 12b for connecting this anchoring part 12a to the lateral wall of the dial ebauche 4a, 4b. The cooperation between the peripheral portion 20b of the inner face 19a of this first part 7a, the receiving face 19b of the second part 7b, and the rest plate 3a, helps to form several peripheral cavities 9b in this mould 2 in each of which the attachment element 10 is designed/made. It should be noted that each of the peripheral cavities 9b comprises the through hole 6b formed in the peripheral part of the plate 3a, 3b. This mould 2 has as many peripheral cavities 9b as the peripheral part of the plate 3a, 3b has through holes 6b. It should be noted that when the rest plate 3a, 3b is arranged in this mould 2, each of these through holes 6b is positioned facing an exit port 23 of an injection circuit 8 defined wholly or in part in the body of the second part 7b. In other words, this receiving face 19b of the second part 7b has as many exit ports 23 as the rest plate 3a, 3b has through holes 6b. These ports 23 are defined in a peripheral part of this face 19b. Each port 23 is connected to the injectable material injection device 11, via the injection circuit 8 defined in the second part 7b of the mould 2.

In this configuration, the exit ports 23 are, in this system 1, the only routes for injecting an injectable material into the mould enclosure 2 in order to design/make both the dial ebauche 4a, 4b and the attachment elements 10. When this injectable material is injected into the enclosure, it first penetrates each peripheral cavity 9b, in particular through each through hole 6b, until it reaches the central cavity 9a. This material then accumulates in the central cavity 9a until it fills it up to form the dial ebauche 4a, 4b. Once the ébauche 4a, 4b has been formed, the material continues to be injected and accumulates in each peripheral cavity 9b to form the attachment elements 10. It should be noted that temperature regulation within the mould 2 used to inject the material into its enclosure is ensured by the circulation of a cooling fluid or a heating fluid in a secondary circuit comprised in the second part 7b. This temperature control is performed by the device 16 that regulates the temperature of the mould 2.

As has been seen, each peripheral cavity 9b forms the attachment element 10 consisting of two parts: the anchoring part 12a and the connecting part 12b. This connecting part 12b consists of the solidified injected material joining the lateral wall of the dial ébauche 4a, 4b to the anchoring part 12a. With regard to the anchoring part 12a, it consists of a first portion which is overmoulded onto the top side 18a of the peripheral part of the rest plate 3a, 3b and of a second portion which is comprised in the through hole 6b. Together, these first and second portions contribute to ensuring robust attachment of the attachment element 10 to the rest plate 3a, 3b and, by extension, of the dial ebauche 4a, 4b in this same plate 3a, 3b. It should be noted that in this configuration, the end of the designed attachment element 10 comprises a breakaway junction part 14 that joins it to the lateral wall of the dial ebauche 4a, 4b. This part 14 is specifically defined so that it can be broken, in particular in the operation to detach the dial ébauche 4a, 4b from the rest plate 3a, 3b.

Moreover, in this configuration, the portion of solidified injectable material that is located at the interface between the exit port 23 comprised between the receiving face 19b of the second part 7b and the corresponding through hole 6b, forms an injection point 13. This injection point 13 has a cross-section that is preferably smaller than that of the through hole 6b and/or that of the exit port 23. It is understood, therefore, that this cross-section of this injection point 13 is smaller than that of the second portion of the anchoring part 12a of the attachment element 10. Such an injection point 13 is configured so that it can be broken, in particular when the rest plate 3a, 3b is detached from this second part 7b. In fact, this injection point 13 helps to hold the rest plate 3a, 3b, and therefore the dial ebauche 4a, 4b, on the second part 7b by joining it to a sprue 22 formed in this mould 2.

It should be noted that this sprue 22, which can be seen in FIGS. 4 to 7, comprises:
a first part formed by the solidification of the injectable material in the central cavity 9a;
a second part formed by the solidification of the injectable material in each peripheral cavity 9b;
a third part formed by the solidification of the injectable material in the injection circuit 8 provided in the second part 7b.

As already mentioned, in this mould 2, the second part 7b is designed to be reversibly assembled with the bottom face 18b of the rest plate 3a, 3b. This second part 7b comprises said at least one injection circuit 8 for injectable material, joined at a first end to the injection device 11 and at each second end comprising the exit port 23 to each through hole in the rest plate 3a. It is understood in this case that the injection circuit 8 comprises as many second ends as it comprises exit ports 23 formed in the receiving face 19b of the second part 7b. It should be noted that when the system 1 is fitted with the vacuum device 15 for the mould 2. This device 15 is configured to create a vacuum in the mould enclosure 2 comprising the central cavity 9a and the peripheral cavities 9b. In this configuration, as previously mentioned, one of the purposes of the second part 7b is to convey the injectable material to each cavity 9a, 9b and, if necessary, to create a vacuum around them.

In this system 1, the injectable material used is, for example, an organic and/or composite material, or a metallic or ceramic material, or a thermoformable, thermosetting or thermoplastic material. Examples of this material can include the following:
SLN-type charged plastic (phosphorescent) and coloured and/or fluorescent pigments;
ceramic-charged polymer with and without colour pigment;
an additive used to impart a metallic or glossy appearance, such as aluminium powder or metallic powder;
an additive to render the polymer conductive (for technical reasons or for chemical/galvanic or other post-treatment);
an additive imparting an aesthetic finish imitating a material (mother-of-pearl, stone, etc.);
an additive imparting specific mechanical and/or tribological characteristics;
BMG, more commonly known as “Bulk Metallic Glass”;
inoxidisable material;
sinterable metallic material;
ceramic;
silicon, and/or
a combination of any of these elements or of several of them.

Referring to FIG. 9, this system 1 uses a method for manufacturing the dial ebauche 4a, 4b of the measuring apparatus mounted in the rest plate 3a, 3b or attached thereto. In other words, this system 1 is configured to use this method for manufacturing this rest plate 3a comprising this dial ébauche 4a, 4b of the measuring apparatus.

This method comprises a step 30 for designing the rest plate 3a, 3b, said step 30 comprising making the central opening 6a through the thickness of the body of this rest plate 3a, 3b, as well as through holes 6b located at the periphery of this opening 6a. It should be noted that in this step 30, the plate 3a, 3b is chosen among plates made of metal, metal alloy and/or polymers.

The method also comprises a step 31 for preparing the central impression 5a and the peripheral impressions 5b in the first part 7a from at least one original part designed for or used in making these said impressions 5a, 5b in the inner face 19a of this first part 7a. In this context, step 31 involves making as many peripheral impressions 5b as there are through holes 6b comprised in the rest plate 3a.

This original part, otherwise referred to as the “master” part, comprises a central portion 20a designed for making the central impression 5a. This central portion 20a has a shape similar to that of the dial ébauche 4a, 4b that will be made/designed. Such a portion also comprises a zone with a surface similar to that of the expected/desired visible face 17a for this dial ébauche 4a, 4b. This original part also comprises a peripheral portion provided with zones for making peripheral impressions 5b. These zones each have a form similar to that of a fastener 10 used to join the designed dial ébauche 4a, 4b to the rest plate 3a, 3b. It should be noted that in one embodiment of the invention, the use of this step 31 can require as many original parts as there are impressions 5a, 5b to be made.

In this context, the preparation step 31 comprises a sub-step 32 for designing said original part using a lithography technique. This lithography technique is chosen among the following techniques known in the prior art and which are not described in greater detail here: optical lithography using ultraviolet projection, optical lithography using UV, MUV or DUV projection, immersion lithography, double patterning lithography, extreme ultraviolet lithography, nanoimprint lithography. It should be noted that other techniques can be used as a complement to, or replacement for, the lithography technique, for example the laser ablation technique.

This preparation step 31 then comprises a sub-step 33 for replicating the original part by reproducing a negative form of this original part. This sub-step 33 provides in particular for the use of replication techniques of the Ni shims or BMG (acronym for “Bulk Metallic Glass”) type known in the prior art and which are not described in greater detail here.

Thereafter, the method comprises a step 34 for forming the central cavity 9a and the peripheral cavities 9b in the enclosure of said mould 2. These peripheral cavities 9b are defined around this central cavity 9a or in its periphery. This step 34 comprises a sub-step for fitting 35 the rest plate 3a, 3b in this enclosure formed by the reversible assembly of the first and second parts 7a, 7b of this mould 2.

In this sub-step 35, the rest plate 3a, 3b is positioned on the receiving face 19b of the second part 7b. The plate 3a, 3b is positioned so that each exit port 23 of the corresponding second end of the injection circuit 8 is joined/connected to a corresponding through hole 6b of the rest plate 3a, 3b. Such a sub-step 35 helps to make an optimal connection between each exit port 23 and each corresponding through-hole 6b of the rest plate 3a, in other words, the through-hole 6b that is intended to cooperate with that exit port 23. It should be understood that this circuit 8 has as many outlet ports 23, and therefore second ends, as the rest plate 3a, 3b has through holes 6b. In this sub-step 35, the top face 18a of the plate 3a, 3b cooperates with the central and peripheral impressions 5a, 5b defined in the inner face 19a of the first part 7a to contribute to the preparation/formation of the dial ébauche 4a, 4b and the elements 10 for attaching this ebauche 4a, 4b to this rest plate 3a, 3b. It should be noted that in this configuration the central opening 6a of the plate 3a, 3b is positioned facing the central impression 5a and the through holes 6b facing the peripheral impressions 5b.

The method then comprises a step 36 for designing said dial ébauche 4a, 4b in the central cavity 9a and the attachment elements 10 in the peripheral cavities 9b. This step 36 comprises a sub-step for injecting material 38 into the mould enclosure 2. In this sub-step 38, the material is injected into the central cavity 9a and the peripheral cavities 9b of this enclosure. This material is injected into the enclosure via each exit port 23 of the circuit 8 comprised in the receiving face 19b of the second part 7b. More specifically, this material first penetrates each peripheral cavity 9b when it is injected via each port 23 into the corresponding through hole 6b of this cavity 9b, until it reaches the central cavity 9a where this material accumulates so as to fill this central cavity 9a to form/design the dial ébauche 4a, 4b.

Once this dial ebauche 4a, 4b has been formed, the material continues to flow from each of these exit ports 23, this time accumulating in each peripheral cavity 9b until it fills it to form the attachment element 10. In this context, the anchoring part 12a of the attachment element 10 consists of its first portion, which is overmoulded onto the top face 18a of the peripheral part of the rest plate 3a, and its second portion, which is formed in the through hole 6b. With regard to the connecting part 12b of this attachment element 10, it is formed so as to extend substantially or strictly perpendicular to the peripheral lateral wall of the designed dial ébauche 4a, 4b. Each connecting part 12b designed in this way comprises the breakaway junction part 14 connecting/binding it to this peripheral lateral wall.

It should be noted that during this step 36, the temperature within the mould 2 is regulated. This temperature regulation contributes to the injection of the material into its enclosure by controlling the circulation of a cooling fluid or a heating fluid in a secondary circuit comprised in the second part 7b. This regulation is performed by the temperature regulation device 16 for this mould 2. The injected material then occupies the entire volume defined in the central cavity 9a and the peripheral cavities 9b of this enclosure.

It should be noted that during this injection sub-step 38, the injection point 13 is made in the interface located between each exit port 23 comprised in the receiving face 19b of the second part 7b and the through hole 6b of the plate 3a, 3b. As already mentioned, this injection point 13 joins the end of each designed attachment element 10 to the end of the sprue 22 comprised in the corresponding exit port 23.

Accordingly, such a design step 36 can comprise the following sub-steps:
creating a vacuum 37 in the central cavity 9a and the peripheral cavities 9b before performing the sub-step 38 for injecting the injectable material into these cavities 9a, 9b, and/or
regulating 39 the temperature of the mould and therefore of these cavities 9a, 9b for:
   a period ranging from before the start of the sub-step for injecting 38 injectable material into the enclosure until the end of this sub-step for injecting 38 material, and/or
   a period starting at the end of this injection 38 sub-step by performing a cooling operation on this enclosure.

Such vacuum and temperature regulation sub-steps 37, 39 are performed to ensure structural homogeneity of the dial ébauche 4a, 4b and the attachment elements 10 in order to eliminate the presence of any defects that may be present in/on this ebauche 3a, 3b and/or these attachment elements 10. Such defects can, for example, be the presence of a weld seam on the visible face 17a of the dial ebauche 4a, 4b following the joining of two flow streams of injectable material in the central cavity 9a.

When the vacuum sub-step 37 is performed, the fluid present in the enclosure, for example a gas such as air, is then evacuated from this enclosure before the injection sub-step 38 is performed.

When performing the sub-step 39 for regulating the hot mould temperature of the enclosure and more specifically of regulating the temperature in this enclosure, the enclosure is then brought to a temperature that is higher or substantially higher than the temperature at which the injectable material supplied by the device 11 for injecting this material transitions from a liquid state to a solid state, before the injection sub-step 38 is performed. For example, this transition temperature is referred to as the glass transition temperature if the material is a thermoplastic. Thereafter, once the injection sub-step 38 of the injectable material has been performed, i.e., completed, this sub-step 39 provides for a cooling operation of the enclosure.

The method then comprises a step 40 for unmoulding the rest plate 3a, 3b comprising the dial ébauche 4a, 4b and the designed attachment elements 10 from said mould 2. This step 40 comprises a sub-step 41 for detaching the first and second parts 7a, 7b from each other. In other words, these first and second parts 7a, 7b are separated from each other. This unmoulding step 40 comprises a sub-step 42 for breaking the injection point 13. This injection point 13 is configured so that breaking it helps/enables a base of the end of each attachment element 10 to be obtained that is substantially flush with the bottom face 18b of the rest plate 3a, 3b. In this sub-step 42, a force is then applied to the rest plate 3a, 3b provided with this dial ebauche 4a, 4b in order to cause a rotational and/or translational displacement of this plate 3a, 3b relative to the exit ports 23 and therefore relative to the second part 7b and thus to cause each injection point 13 to break. It will be noted that once the injection points 13 have been broken, the now free end of each attachment element 10, and in particular of the second portion of its anchoring part 12a, has a base that is substantially flush with the bottom face 18b of the rest plate 3a, 3b or strictly flush with this bottom face 18b.

Once the rest plate 3a, 3b is extracted from the mould 2 with the designed dial ebauche 4a, 4b firmly attached to it, this plate 3a, 3b can then be freely manipulated without this ebauche detaching from the body of this plate 3a, 3b. For example, this plate 3a, 3b can be handled so as to be fitted/mounted on a receiving base in the system for finishing this ébauche 4a, 4b. Such a base is configured to receive this plate 3a, 3b so that finishing operations can be performed on this dial ébauche 4a, 4b. It should be noted that fitting this plate 3a, 3b on this base is facilitated by the second portion of the anchoring part 12a of each attachment element, which has a base that is flush with the bottom face 18b of the rest plate 3a, 3b. In other words, the rest plate 3a, 3b comprising this dial ébauche 4a, 4b, retains a bottom face 18b that remains flat.

By way of example, such a finalisation system can include:
designing, mounting or applying at least one pattern on the visible outer face 17a of the dial ébauche 4a, 4b;
applying a plating to all or part of said dial ébauche 4a, 4b, for example by depositing decorative and/or functional material on said visible face 17a.

Furthermore, once the dial ébauche 4a, 4b has been finished, it is detached from the rest plate 3a, 3b so that it can be mounted in a measuring apparatus. Indeed, the end of each attachment element 10 is joined to the dial ébauche 4a, 4b by the breakaway junction part 14 which is configured to break when a force is applied to the dial ébauche 4a, 4b so as to detach/separate this dial ébauche 4a, 4b from the rest plate 3a, 3b.

### Terminology

1. Manufacturing system
2. Mould
3a, 3b. Rest plate
4a, 4b. Dial ébauche
5a. Central impression
5b. Peripheral impression
6a. Central through opening
6b. Through holes
7a. First part
7b. Second part
8. Injection circuit
9a. Central cavity
9b. Peripheral cavities
10. Attachment element
11. Injection device
12a. Anchoring part of the attachment element
12b. Connecting part of the attachment element
13. Injection point
14. Breakaway junction part
15. Vacuum device
16. Regulation device
17a. Visible face of the dial ebauche
17b. Hidden face of the dial ebauche
18a. Top face of the rest plate
18b. Bottom face of the rest plate
19a. Inner face of the first part
19b. Face for receiving the second part
20a. Centre portion of inner face
20b. Peripheral portion of the inner face
21. Central zone of the receiving face
22. Sprue
23. Injection circuit exit port
24. Rest plate bed
25. Unmoulding and fitting device

1. A method for manufacturing a dial ébauche (4a, 4b) of a measuring apparatus mounted in a rest plate (3a, 3b) comprising:
a step (34) for forming, in an enclosure of said mould (2), a central cavity (9a) and peripheral cavities (9b) defined around this central cavity (9a), said step (34) providing for fitting (35) the rest plate (3a, 3b) in this enclosure formed by a reversible assembly of first and second parts (7a, 7b) of this mould (2);
a step (36) for designing said dial ébauche (4a, 4b) in the central cavity (9a) and attachment elements (10) in the peripheral cavities (9b), and
a step (40) for unmoulding the rest plate (3a, 3b) from said mould (2), the plate comprising the dial ébauche (4a, 4b) and the designed attachment elements (10), ensuring the attachment of said ébauche (4a, 4b) in said plate (3a, 3b).

2. The method according to claim 1, wherein, during the fitting (35) of the rest plate (3a, 3b) in said enclosure, a central opening (6a) and through holes (6b) of said plate (3a, 3b) are arranged, respectively, facing a central impression (5a) and peripheral impressions (5b) defined in an inner face (19a) of the first part (7a), said face (19a) contributing to delimiting said enclosure of the mould (2).

3. The method according to claim 1, wherein, during the fitting (35) of the rest plate (3a, 3b) in said enclosure, exit ports (23) of a material injection circuit (8) comprised in a flat receiving face (19b) of the second part (7b) are each connected to a through hole (6b) of said plate (3a, 3b).

4. The method according to claim 1, wherein, in the design step (36), material is injected (38) into the central cavity (9a) and peripheral cavities (9b) of the mould (2) via exit ports (23) comprised in the receiving face (19b) of the second part (7b).

5. The method according to claim 1, wherein, when injected (38), the material first penetrates into each peripheral cavity (9b) until it reaches the central cavity (9a), where it accumulates to form the dial ébauche (4a, 4b).

6. The method according to claim 1, wherein once the dial ébauche (4a, 4b) has been designed, the injected material continues to flow through the exit ports (23) while accumulating in each peripheral cavity (9b) in order to form the attachment element (10) provided with a breakaway junction part (14) joining it to said dial ébauche (4a, 4b).

7. The method according to claim 1, wherein the design step (36) comprises making an injection point (13) in an interface located between an exit port (23) comprised in a receiving face (19b) of the second part (7b) and a through hole (6b) of the plate (3a, 3b).

8. The method according to claim 1, wherein the design step (36) comprises regulating (39) the temperature of the enclosure by performing an operation in which the enclosure is cooled when the injection of material into said enclosure is complete.

9. The method according to claim 1, wherein the unmoulding step (40) comprises detaching (41) the first and second parts (7a, 7b) from each other.

10. The method according to claim 1, wherein the unmoulding step (40) comprises detaching (41) the first and second parts (7a, 7b) from each other and provides for a breaking away (42) the injection point (13) configuring a base of one end of each attachment element (10) flush with the bottom face (18b) of the rest plate (3a, 3b).

11. The method according to claim 1, comprising a step (30) for designing the rest plate (3a, 3b) by making, in the thickness of the body of this plate (3a, 3b), the central through opening (6a) and a plurality of through holes (6b) located at the periphery of this opening (6a).

12. The method according to claim 1, comprising a step (31) for preparing a central impression (5a) and peripheral impressions (5b) in the first part (7a) from at least one original part configured for making these said impressions (5a, 5b) in the inner face (19a) of this first part (7a).

13. The method according to claim 1, wherein said measuring apparatus is a watch.

14. A system (1) for manufacturing a dial ébauche (4a, 4b) of a measuring apparatus mounted in a rest plate (3a, 3b) using the method according to claim 1, the system (1) comprising a mould (2) comprising an enclosure including a central cavity (9a) and peripheral cavities (9b) defined around this central cavity (9a), said enclosure being formed by a reversible assembly of first and second parts (7a, 7b) of this mould (2), said parts (7a, 7b) being configured to receive said rest plate (3a, 3b), said central and peripheral cavities (9a, 9b) being configured for the design of the dial ébauche (4a, 4b) and attachment elements (10) ensuring the attachment of said ébauche (4a, 4b) to said plate (3a, 3b).
